(19) United States
(12) Patent Application Publication
(10) Pub. No.: US 2011/0044324 A1
(43) Pub. Date: Feb. 24, 2011

(54) Method and Apparatus for Voice Communication Based on Instant Messaging System

(75) Inventors: Dalong Li, Shenzhen city (CN); Quanzhan Zheng, Shenzhen city (CN); Fuzhong Sheng, Shenzhen city (CN)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: TENCENT TECHNOLOGY (SHENZHEN) COMPANY LIMITED, Shenzhen (CN)

(21) Appl. No.: 12/913,358

(22) Filed: Oct. 27, 2010

Related U.S. Application Data
(63) Continuation of application No. PCT/CN2009/071931, filed on May 22, 2009.

(30) Foreign Application Priority Data
Jun. 30, 2008 (CN) 200810068262.6

(51) Int. Cl. H04L 12/66

(52) U.S. Cl. 370/352

(57) ABSTRACT

Embodiments of the present invention provide a method and apparatus for voice communication based on an IM system. The method includes: a) establishing a tone-modified voice communication channel between second IM client and first IM client; b) processing inputted original voice information through tone modification to obtain tone-modified voice; sending the tone-modified voice to the first IM client via the tone-modified voice communication channel. According to embodiments of the present invention, the voice information collected in the IM system is first processed through tone modification, thereby tone-modified voice communication based on the IM system is implemented.

### FIELD OF THE INVENTION

The present invention relates to communications technology, and particularly, to a method and apparatus for voice communication based on an Instant Messaging (IM) system.

### BACKGROUND OF THE INVENTION

Along with the development of IM technology, an IM system has been equipped with other additional functions, such as a voice communication function, besides basic IM functions. Using the IM system for voice communication has become one of popular communication manners used by people. However, the existing voice communication manner has simplex functions, i.e., the voice communication can only use original voices of the two parties in the voice communication but can not change the voices of the two parties. As a result, identities of the two parties can not be hidden. And thus the existing voice communication manner lacks novelty and attraction, and can not satisfy users' requirements of being individualized.

At present, there is no tone-modified voice communication method based on the IM system.

### SUMMARY OF THE INVENTION

Embodiments of the present invention provide a method for tone-modified voice communication based on an IM system to solve a problem that currently there is no method for voice communication based on the IM system with tone modified.

The present invention is achieved through the following technical scheme.

A method for IM-based voice communication includes:

a) establishing a tone-modified voice communication channel between at least two IM clients;

b) processing original voice information through tone modification to obtain tone-modified voice; and transmitting the tone-modified voice to a first IM client of the at least two IM clients via the tone-modified communication channel.

Embodiments of the present invention also provide an apparatus for voice communication based on Instant Messaging (IM) system, and the apparatus includes:

a request sending unit, adapted to establish a tone-modified voice communication channel;

a voice collecting unit, adapted to collect original voice information inputted;

a tone modifying unit, adapted to process the original voice information collected by the voice collecting unit through tone modification to obtain tone-modified voice;

a voice sending unit, adapted to send the tone-modified voice obtained by the tone modifying unit via the tone-modified voice communication channel established by the request transmitting unit.

Embodiments of the present invention also provide a method for voice communication based on an Instant Messaging (IM) system, including steps of:

establishing a voice communication channel between at least two IM clients;

processing original voice information through tone modification to obtain tone-modified voice after determining to perform tone-modified voice communication; and transmitting the tone-modified voice to a first IM client of the at least two IM clients via the voice communication channel.

According to embodiments of the present invention, the voice information collected in the IM system is first processed through tone modification, thereby tone-modified voice communication based on the IM system is implemented. The voice communication in the IM system is made more entertaining, and may introduce new spin-offs to value-added services of conventional IM services. The IM services will become more attractive to users and thus become more competitive and bring brand-new service experiences to voice communicating users.

### BRIEF DESCRIPTION OF THE DRAWINGS

FIG. 1 is a flowchart illustrating a basic process of a method in accordance with an embodiment of the present invention.

FIG. 2 is a flowchart illustrating a detailed process of a method in accordance with an embodiment of the present invention.

FIG. 3 is a flowchart illustrating a detailed process of a method in accordance with an embodiment of the present invention.

FIG. 4 is a flowchart illustrating a process after IM client B receives tone-modified voice communication data sent by IM client A in accordance with an embodiment of the present invention.

FIG. 5 is a schematic diagram illustrating a basic structure of an apparatus in accordance with an embodiment of the present invention.

FIG. 6 is a schematic diagram illustrating a detailed structure of an apparatus in accordance with an embodiment of the present invention.

### DETAILED DESCRIPTION OF THE INVENTION

This invention is hereinafter further described in details with reference to the accompanying drawings as well as embodiments so as to make the objective, technical solution and merits thereof more apparent.

In an embodiment of the present invention, a tone-modified voice communication channel may be established between at least two IM clients. For example, a tone-modified voice communication channel may be established between IM client A, IM client B and IM client C. For description convenience, the following description takes establishing a tone-modified voice communication channel between IM client A and IM client B as an example, and similar processes can be applied to other situations which will not be elaborated on. Specifically, IM client A sends a tone-modifying request to IM client B, and establishes a tone-modified voice communication channel with IM client B. Then, IM client A processes original voice collected through tone modification to obtain tone-modified voice of the original voice, and sends the tone-modified voice to IM client B via the tone-modified voice communication channel established, thereby implementing tone-modified voice communication between IM clients in an IM system.

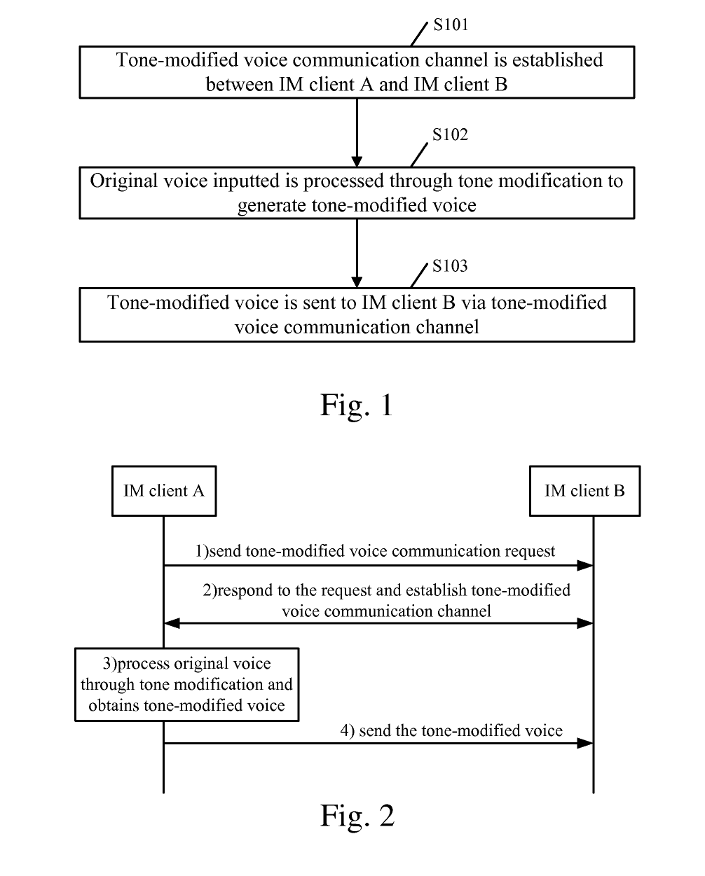

Referring to FIG. 1, which is a flowchart illustrating a basic process of a method in accordance with an embodiment of the present invention. As shown in FIG. 1, this embodiment takes establishing a tone-modified voice communication channel between IM client A and IM client B as an example. The process may include steps as follows.

In step S101, a tone-modified voice communication channel is established between IM client A and IM client B.

In step S102, original voice inputted is processed through tone modification to generate tone-modified voice.

In step S103, the tone-modified voice is sent to IM client B via the tone-modified voice communication channel.

It should be noted that IM client A and IM client B may be implemented by various forms, such as a web-formed client or a wireless client, and are not limited to examples for describing the present invention.

It should also be noted that the operations in steps S102 and S103 can be carried out by IM client A, e.g., IM client A processes original voice through tone modification to obtain tone-modified voice, and sends the tone-modified voice to IM client B through the tone-modified voice communication channel in a server-forwarding manner or in a P2P manner. Alternatively, the operations may be carried out by a pre-designated tone-modifying device, such as a server, e.g., a server receives original voice sent by IM client A, processes the original voice through tone modification to obtain tone-modified voice; and sends the tone-modified voice to IM client B via the tone-modified voice communication channel. Detailed implementation will not be limited in the present invention. For facilitating description, voice communication between two clients is taken as an example in the following description.

In the above, the basic process of the voice communication based on an IM system according to embodiments of the present invention is implemented.

The above describes the process of the embodiments of the present invention in general, and the process will be described in detail with reference to the embodiments.

Referring to FIG. 2, FIG. 2 is a flowchart illustrating a detailed process of a method in accordance with an embodiment of the present invention, and details are as follows.

1) IM client A sends a request for performing tone-modified voice communication to IM client B.

2) IM client B receives the request for performing tone-modified voice communication from IM client A, responds to the request, and returns response information to IM client A. When receiving the response for performing tone-modified voice communication from IM client B, IM client A establishes a tone-modified voice communication channel between IM client A and IM client B.

In order to establish the communication channel successfully, IM client A and IM client B establish the tone-modified voice communication channel with coordination of an IM server. Certainly, IM client A may transparently or non-transparently send the request for performing tone-modified voice communication to IM client B. Specifically, if IM client A transparently sends the request for performing tone-modified voice communication to IM client B, this procedure need not be displayed in an interface of IM client B.

3) IM client A processes collected original voice through tone modification, and obtains tone-modified voice corresponding to the original voice.

Embodiments of the present invention provide pluralities of tone-modifying methods, such as changing the tone of the original voice, changing the sex of the original voice (i.e., changing male voice into female voice or changing female voice into male voice), changing the age of the original voice (e.g., changing a youth voice into voice of an elderly person), changing the original voice of a user into voice of a celebrity, adding background sound into the original voice (strictly speaking: adding background sound into user's voice is not a type of voice tone-modifying but a type of sound mixing; but the voice tone-modifying of the present invention includes such sound mixing).

The detailed process of processing the collected original voice through tone modification to obtain tone-modified voice may include the following procedure:

A) collecting voice information inputted by a user and processing the voice information collected to generate a digital voice signal identifiable and processable by a computer;

B) processing the digital voice signal through tone modification and obtaining tone-modified voice corresponding to the digital voice signal.

In this embodiment, the tone modification may be implemented by: dissolving the digital voice signal using a Linear Prediction (LP) analyzing and synthesizing model into a spectrum envelope part (denoted by Linear Predictive Coding (LPC)) and an excitation part (denoted by residual of the LPC); obtaining a formant frequency and a spectral tilt parameter from an LPC coefficient, and implement voice conversion using a vector quantization codebook manner. With respect to conversion functions, conversion of frequency envelop may adopt vector quantization, and conversion of prosody (mainly refers to pitch period) may adopt time domain pitch synchronous overlap-add (TD-PSOLA) algorithm.

In this embodiment, the manner of tone modification to be adopted should be determined before performing tone modification. Specifically, determining the tone modification manner to be adopted currently may include: determining current tone modification information, and determining the tone modification manner to be adopted according to the current tone modification information. The current tone modification information may include: user selection information, and/or authorized tone modification information. The user selection information is a selection chosen by the user from provided tone modification manners; the authorized tone modification information is tone modification information authorized by the IM system for the user to perform tone modification.

Preferably, to generate new spin-offs in value-added services of the conventional IM service, the IM service provider may provide some of tone modification manners as items of value-added services. According to embodiments of the present invention, provided tone modification manners can be determined based on authorized tone modification manners of the user initiating tone modification in the IM system. Before a user of IM client A selects a tone modification manner, the user may send authorized modification manner query information to a server via IM client A, and according to a user identification of the user in the IM system, the server returns authorized tone modification manner information, i.e. tone modification manners that can be used by the user. Preferably, a user of IM client A may input user selection information based on the authorized tone modification information to determine a tone modification manner to be adopted based on the user selection information and the authorized tone modification information returned by the server. Other service selection logic may also be used for determining the tone modification manner based on the user selection information and the authorized tone modification manner information; when the user has only one available tone modification manner, the tone modification manner can be determined based on the authorized tone modification manner information.

The tone modification is performed based on original voice signals of the user. Therefore, when determining the tone modification manner for modifying the original voice, a preferred embodiment also takes user characteristic information into consideration, such as segmental features of the original voice of the user, so as to provide a more proper tone modification manner for the user so that the tonal-modified voice can be recognized by a person whom the user is communicating with. And the tone modification manner can be determined by the service selection logic based on the user selection information and the user characteristic information, or based on the user selection information, the authorized tone modification information and the user characteristic information. The service selection logic is defined by an IM service provider, and specifies how many tone modifying service items (e.g. “changing male voice into female voice” is one tone modifying service item) are available to certain authorized tone modification information and certain voice communication environment, and then the service selection logic is used for determining the tone modification manner.

After receiving the user selection information, IM client A analyzes original voice signals of the user to obtain the user characteristic information. When the user characteristic information does not meet requirements of the tone modification, the tone modification manner requested by the user may be modified. For example, when the original voice of a user is deep and hoarse and the user selects a tone modification manner of “child's voice”, the effect of the tone modification will be poor (can not be recognized as “child's voice”). Therefore, the system may suggest the user to select another tone modification manner.

To improve the quality of voice heard by the receiving person of communication and to provide a proper tone modification manner for users, another preferred embodiment further takes voice environment information of the receiving person into account. And the tone modification manner can be determined by the service selection logic based on the user selection information and the voice environment information of the receiving person, or based on the user selection information, the authorized tone modification information and the voice environment information of the receiving person. The voice environment information of the receiving person is sent by IM client B to IM client A when IM client B returns the response to the tone-modified voice communication request to IM client A. The voice environment information can be selected by a user of IM client B, or obtained by IM client B based on analysis of voice signals collected by a micro-phone.

According to embodiments of the present invention, the tone modification manner of IM client A can be determined by the service selection logic based on the user selection information and any or any combination of the authorized tone modification manner information, the user characteristic information and the voice environment information of the receiving person.

In embodiments of the present invention, collected voice information may contain signals such as echo and noise which adversely affects processing, transport and identification of the voice information. Therefore, before the digital voice information is processed through tone modification, the digital voice information should be processed through noise removing, i.e. any or any combination of echo cancellation, noise reduction and signal gain control and the like, so as to achieve better effect of tone-modified voice communication and improve voice quality heard by the receiving person.

4) IM client A sends the tone-modified voice obtained to IM client B via the tone-modified voice communication channel established.

According to embodiments of the present invention, in order to facilitate transport of the tone-modified voice, IM client A may group and pack the tone-modified voice before sending the tone-modified voice to obtain tone-modified voice packets, and then send the tone-modified voice packets to IM client B.

In embodiments of the present invention, after tones of the collected original voice are modified, the tone-modified voice corresponding to the collected original voice is compressed and coded according to a preset coding rule, such as G.729, G.729, G.723.1, so that bandwidth needed for transporting the tone-modified voice data is reduced and real time tone-modified voice communication is thus facilitated.

To avoid signal distortion due to packet loss and errors in network transport, after the tone-modified voice is compressed and coded, bit streams obtained after the compressing and coding are processed through redundancy enhancing by using channel coding technique.

The process of IM client B sending a tone-modified voice communication request to IM client A is similar to the process described above, and will not be described herein. It can be understood that IM client A and IM client B may perform one-way tone-modified voice communication or bi-directional tone-modified voice communication. The above voice communication may be performed in an IM system based on a wired network or a wireless network.

When any of IM client A and IM client B requests disconnection or when the network is in failure, the communication is terminated and the tone-modified voice communication channel is released.

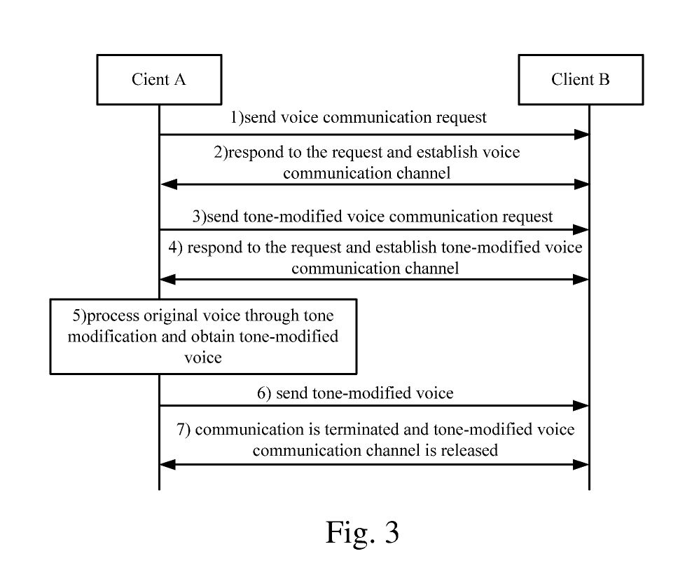

FIG. 3 is a flowchart illustrating the method in accordance with an embodiment of the present invention. According to this embodiment, a voice communication channel is established between IM client A and IM client B, and IM client A and IM client B perform voice communication. The method may include steps as follows:

1) IM client A sends a voice communication request to IM client B.

2) IM client B responds after receiving the voice communication request from IM client A, and returns response information to IM client A. When receiving the response information for performing voice communication from IM client B, IM client A establishes a voice communication channel between IM client A and IM client B.

After establishing the voice communication channel, IM client A and IM client B may perform voice communication with each other via the voice communication channel.

3) IM client A sends a tone-modified voice communication request to IM client B.

4) IM client B responds after receiving the tone-modified voice communication request from IM client A, and returns response information to IM client A. When receiving the response information for performing tone-modified voice communication from IM client B, IM client A establishes a tone-modified voice communication channel between IM client A and IM client B.

After the tone-modified voice communication channel is established, the voice communication channel established previously may be released. IM client A may send the tone-modified voice communication request transparently or non-transparently to IM client B. If IM client A transparently sends the tone-modified voice communication request to IM client B, this procedure will not be displayed in an interface of IM client B.

5) IM client A processes collected original voice through tone modification, and obtains tone-modified voice corresponding to the original voice.

6) IM client A sends the tone-modified voice to IM client B via the tone-modified voice communication channel established.

It should be noted that this embodiment takes establishing a tone-modified voice communication channel between IM client A and IM client B after establishing a voice communication channel between IM client A and IM client B as an example. To make this embodiment simpler and easier to be implemented, IM client A may not establish the tone-modified voice communication channel with IM client B after receiving the response information for performing tone-modified voice communication from IM client B, but just use the voice communication channel established in step 2) to send the tone-modified voice to IM client B. Therefore, the operation of establishing the tone-modified voice communication channel in step 4) can be omitted. Preferably, one of criteria for determining whether to establish the tone-modified voice communication channel may be determining whether the bandwidth of the voice communication channel is adequate for transporting the tone-modified voice obtained in step 5).

7) The tone-modified voice communication channel is released when the communication is terminated.

When any of IM client A and IM client B requests disconnection or when the network is in failure, the communication is terminated and the tone-modified voice communication channel is released.

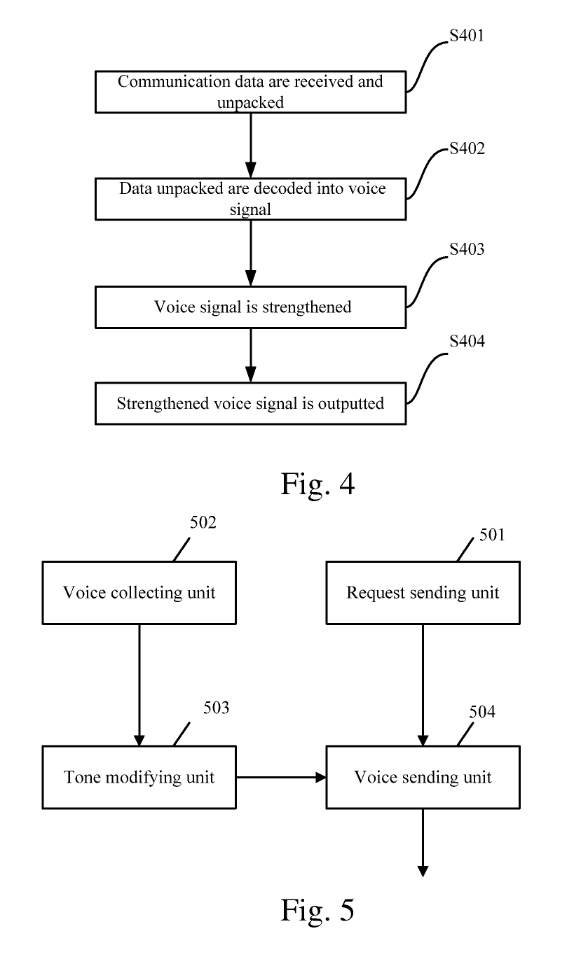

After IM client B receives tone-modified voice communication data sent by IM client A, the processing of communication data performed by IM client B is similar to the processing in ordinary voice communication. The processing is shown in FIG. 4, and may include the following:

In S401, communication data are received and unpacked.

Communication data packets are received via the tone-modified voice communication channel established, unpacked according to the same network transport protocol adopted by IM client A, and assembled to obtain a compressed code streams.

In S402, the unpacked data are decoded into voice signals.

The unpacked compressed-code-streams are decoded by utilizing an inverse operation of a coding operation of IM client A to obtain voice signals which are identifiable by human ears.

In S403, the voice signals are strengthened.

The voice signals may be distorted due to network transport, voice signal compression, voice tone modification and so on. Therefore, signal strengthening is necessary for the voice signals obtained by decoding. The signal strengthening may adopt Kalman filtering, Minimum Mean Squared Error (MMSE) short time spectral amplitude estimation, or adaptive filtering and so on.

In S404, the strengthened voice signals are outputted.

The strengthened voice signals are outputted via an output device, such as earphone, sound box and sound card.

To obtain voice bit streams that can be decoded correctly, the data after being received and unpacked may be processed through redundancy removing/error toleration, so as to remove redundant signals inserted by IM client A into the compressed code streams and to modify or discard erroneous data therein.

The above described the method provided by embodiments of the present invention in detail, and the following will describe the apparatus provided by embodiments of the present invention.

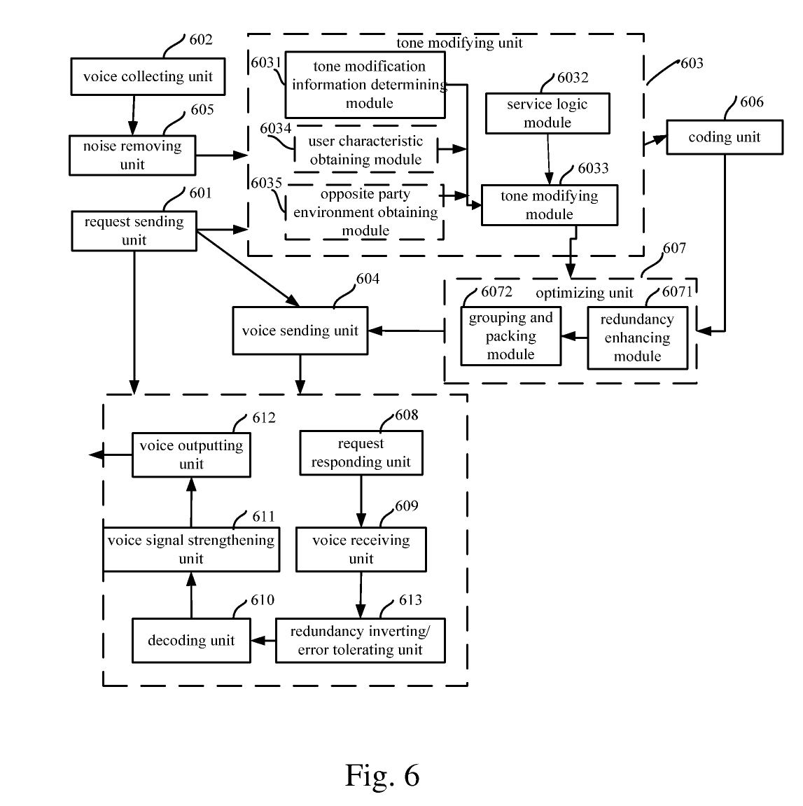

FIG. 5 is a schematic diagram illustrating a basic structure of an apparatus in accordance with an embodiment of the present invention. As shown in FIG. 5, the apparatus may include a request sending unit 501, a voice collecting unit 502, a tone modifying unit 503 and a voice sending unit 504.

The request sending unit 501 is adapted to establish a tone-modified voice communication channel.

The voice collecting unit 502 is adapted to collect original voice information inputted.

The tone modifying unit 503 is adapted to process the original voice information collected by the voice collecting unit 502 through tone modification to obtain tone-modified voice.

The voice sending unit 504 is adapted to send the tone-modified voice obtained by the tone modifying unit 503 via the tone-modified voice communication channel established by the request sending unit 501.

The foregoing implements a basic apparatus for voice communication based on an IM system.

To make the apparatus for voice communication based on the IM system clearer, the structure of the apparatus according to embodiments of the present invention will be described in detail hereinafter.

FIG. 6 is a block diagram illustrating a detailed structure of an apparatus in accordance with an embodiment of the present invention. Referring to FIG. 6, only the parts relative to the embodiment of the present invention are shown in FIG. 6 to be concise.

The apparatus may be applied to any IM client device, such as a computer, a lap-top computer, a Personal Digital Assistant (PDA) and an intelligent phone, and can be a software unit, or a hardware unit, or a combined unit of software and hardware in the above IM client devices, or be an independent plug-in integrated in the IM client devices or operating in the application system of the IM client devices. Specifically, the apparatus may include: a request sending unit 601, a voice collecting unit 602, a tone modifying unit 603 and a voice sending unit 604.

The request sending unit 601 is adapted to establish a tone-modified voice communication channel.

The voice collecting unit 602 is adapted to collect original voice information inputted.

The tone modifying unit 603 is adapted to process the original voice information collected by the voice collecting unit 602 through tone modification to obtain tone-modified voice.

The voice sending unit 604 is adapted to send the tone-modified voice obtained by the tone modifying unit 603 via the tone-modified voice communication channel established by the request sending unit 601.

It should be noted that the request sending unit 601, the voice collecting unit 602, the tone modifying unit 603 and the voice sending unit 604 may reside in the same entity, e.g. in IM client A, or may reside in different entities, e.g. the request sending unit 601 and the voice collecting unit 602 are in the same entity such as IM client A while the tone modifying unit 603 and the voice sending unit 604 are in a preset tone modifying device such as a server. Detailed implementing manners depend on specific situations, and are not limited in the present invention.

Specifically, the request sending unit 601 establishes a tone-modified voice communication channel after receiving a response for performing tone-modified voice communication. The response for performing tone-modified voice communication is a response to the tone-modified voice communication request sent by the request sending unit 601. In this embodiment, the request sending unit 601 may also be adapted to receive information of the tone-modified voice communication request inputted by a user.

The voice collecting unit 603 is further adapted to convert voice information collected into digital voice information. The digital voice information is identifiable and processable by a computer.

In this embodiment, the tone modifying unit 603 may include: a tone modification information determining module 6031, a service logic module 6032 and a tone modifying module 6033.

The tone modification information determining module 6031 is adapted to determine and output current tone modification information. The current tone modification information includes user selection information and/or authorized tone modification information.

The service logic module 6032 is adapted to generate service selection logic, which is adapted to perform tone modification and output tone-modified voice to the tone modifying module 6033. The service selection logic is defined by an IM service provider, and specifies how many tone modifying service items (e.g., “changing male voice into female voice” can be one tone modifying service item) are available to certain authorized tone modification information and a certain voice communication environment.

The tone modifying module 6033 is adapted to determine a tone modification manner based on the received tone modification information outputted by the tone modification information determining module 6031 and the service selection logic outputted by the service logic module 6032, perform tone modification to the digital voice information obtained by the voice collecting unit 602 according to the tone modification manner, and output tone-modified voice corresponding to the digital voice information. Specifically, the tone modifying module 6033 uses the service selection logic for determining the tone modification manner based on the user selection information and/or the authorized tone modification information included in the tone modification information. Detailed implementation is similar to the forgoing, and will not be described further.

In order to provide a more proper tone modification manner for the user to ensure that the tone-modified voice can be recognized by a receiving person whom the user is communicating with, the tone modifying unit 603 further includes a user characteristic obtaining module 6034 according to a preferred embodiment of the present invention.

The user characteristic obtaining module 6034 is adapted to obtain characteristic information from the digital voice information obtained by the voice collecting unit 602, generate and output the characteristic information.

Thus, the tone modifying module 6033 uses the service selection logic to determine the tone modification manner based on the user selection information and/or authorized tone modification information extracted from the current tone modification information received and further based on the user characteristic information received.

In order to improve the quality of voice heard by the receiving person of communication and to provide proper tone modification manner for the user, the tone modifying unit 603 further includes an opposite party environment obtaining module 6035 according to another preferred embodiment.

The opposite party environment obtaining module 6035 is adapted to obtain opposite party voice environment information contained in the tone-modified voice communication response received by the request sending unit 601. In this embodiment, the tone-modified voice communication response returned by the receiving party includes voice environment information, and the request sending unit 601 generates the opposite party environment information based on the voice environment information received. Then the opposite party environment obtaining module 6035 obtains the opposite party voice environment information generated by the request sending unit 601.

However, the user characteristic obtaining module 6034 and the opposite party environment obtaining module 6035 may not be included in the apparatus all the time. Preferably, the apparatus in an embodiment may include one or both of the user characteristic obtaining module 6034 and the opposite party environment obtaining module 6035. FIG. 6 illustrates an example that the tone modifying unit 603 includes the user characteristic obtaining module 6034 and the opposite party environment obtaining module 6035.

Thus, the tone modifying module 6033 may determine a tone modification manner based on the service selection logic sent by the service logic module 6032, the current tone modification information sent by the tone modification information determining module 6031, and the characteristic information sent by the user characteristic obtaining module 6034; or based on the service selection logic sent by the service logic module 6032, the current tone modification information sent by the tone modification information determining module 6031, and the opposite party voice environment information sent by the remote environment obtaining module 6035; or based on the service selection logic sent by the service logic module 6032, the current tone modification information sent by the tone modification information determining module 6031, the characteristic information sent by the user characteristic obtaining module 6034, and the opposite party voice environment information sent by the remote environment obtaining module 6035.

In order to obtain a better effect of the tone-modified voice communication and improve the quality of voice heard by a receiving person of the voice communication, the apparatus may further include a noise removing unit 605 according to another preferred embodiment of the present invention.

The noise removing unit 605 receives the digital voice information obtained by the voice collecting unit 602, performs noise removing, and obtains digital voice information from which noise is removed.

In order to reduce bandwidth needed for transporting tone-modified voice communication data for implementing real time tone-modified voice communication, the apparatus may further include: a coding unit 606 and/or an optimizing unit 607 according to yet another preferred embodiment of the present invention. FIG. 6 illustrates an example that the apparatus includes a coding unit 606 and an optimizing unit 607.

The coding unit 606 is adapted to compress and code the tone-modified voice obtained by the tone modifying unit 603, and obtain tone-modified voice bit streams.

The optimizing unit 607 is adapted to perform redundancy enhancing and/or grouping and packing to the tone-modified voice bit streams obtained by the coding unit 606, and output the tone-modified voice data after processed to the voice sending unit 604. The optimizing unit 607 is mainly used for preventing the tone-modified voice from being distorted due to packet loss and errors during network transport, or used for making the tone-modified voice transported conveniently. When the apparatus does not include the coding unit 606, the optimizing unit 607 may perform redundancy enhancing and/or grouping and packing to the tone-modified voice obtained by the tone modifying unit 603, and output the tone-modified voice data processed to the voice sending unit 604.

As shown in FIG. 6, the optimizing unit 706 in this embodiment may include:

a redundancy enhancing module 6071, adapted to perform redundancy enhancing to the tone-modified voice bit streams obtained by the coding unit 606 or to the tone-modified voice obtained by the tone modifying unit 603, and output the tone-modified voice bit streams after processed;

a grouping and packing module 6072, adapted to group and pack the tone-modified voice data received to obtain tone-modified voice data packets. The grouping and packing module 6072 may receive the tone-modified voice or tone-modified voice bit streams outputted respectively by the tone modifying unit 603, the coding unit 606 or the redundancy enhancing module 6071.

It should be noted that the optimizing unit 607 may only include the redundancy enhancing module 6071 or the grouping and packing module 6072.

As shown in FIG. 6, in order to receive and process voice information, the apparatus may further include the following units.

A request responding unit 608 is adapted to receive a tone-modified voice communication request sent by a request sending unit 601, return a tone-modified voice communication response, and generate and output voice receiving trigger information to a voice receiving unit 609.

The voice receiving unit 609 is adapted to receive the voice receiving trigger information outputted by the request responding unit 608, if data packets currently received are processed through grouping or packing, unpack the data packets according to the same network transport protocol adopted by an opposite party of the voice communication, and assemble the grouped data to obtain and output compressed code streams.

A decoding unit 610 is adapted to decode the data obtained by the voice receiving unit 609, i.e. the compressed code streams, to generate a voice signal.

A voice signal strengthening unit 611 is adapted to decode the data obtained by the decoding unit 610, i.e. decode the voice signal, to obtain a voice signal after decoded, and perform signal strengthening to the voice signal obtained by decoding to obtain a strengthened voice signal.

A voice outputting unit 612 is adapted to output the strengthened voice signal, and may be an earphone, a sound box or a sound card.

If the data packets currently received by the voice receiving unit 609 include a redundant signal inserted into the compressed code streams, the apparatus may further include: a redundancy inverting/error tolerating unit 613.

The redundancy inverting/error tolerating unit 613 is adapted to remove the redundant signal inserted by an opposite party of the voice communication from the compressed code streams received by the voice receiving unit 609, and modify or discard erroneous data. Thus, the voice quality can be improved greatly.

Preferably, the request responding unit 608, the voice receiving unit 609, the decoding unit 610, the voice signal strengthening unit 611, the voice outputting unit 612 and the redundancy inverting/error tolerating unit 613 may be in a communication entity different from which includes the request sending unit 601, the voice collecting unit 602, the tone modifying unit 603, the voice sending unit 604, the noise removing unit 605, the coding unit 606 and the optimizing unit 607. For example, if the request sending unit 601, the voice collecting unit 602, the tone modifying unit 603, the voice sending unit 604, the noise removing unit 605, the coding unit 606 and the optimizing unit 607 reside in one entity, e.g. IM client A, the request responding unit 608, the voice receiving unit 609, the decoding unit 610, the voice signal strengthening unit 611, the voice outputting unit 612 and the redundancy inverting/error tolerating unit 613 may reside in an opposite end of IM client A, e.g. IM client B. Certainly, if the request sending unit 601 and the voice collecting unit 602 reside in one entity, e.g. IM client A, and if the tone modifying unit 603 and the voice sending unit 604 reside in a preset tone modifying device, e.g. server 1, the request responding unit 608, the voice receiving unit 609, the decoding unit 610, the voice signal strengthening unit 611, the voice outputting unit 612 and the redundancy inverting/error tolerating unit 613 may reside in an opposite party of server 1, e.g. IM client B. The above is merely an example, and should not be used for limiting the scope of the present invention.

According to embodiments of the present invention, the voice signal collected in an IM system is first processed through tone modification, and thereby the tone-modified voice communication based on the IM system is implemented. The voice communication in the IM system is made more entertaining, and may become new value-added service spin-offs of the conventional IM service. The IM service will become more attractive to users and thus becomes more competitive. It also provides brand-new service experiences for voice communication users, such as protecting user identities by communicating using tone-modified voice.

The foregoing description is only preferred embodiments of the present invention and is not for use in limiting the protection scope thereof. All the modifications, equivalent replacements or improvements in the scope of the present invention's principles shall be included in the protection scope of the present invention.

What is claimed:

1. A method for voice communication based on Instant Messaging (IM), comprising steps of:
a) establishing a tone-modified voice communication channel between at least two IM clients;
b) processing original voice information through tone modification to obtain tone-modified voice; and transmitting the tone-modified voice to a first IM client of the at least two IM clients via the tone-modified voice communication channel.

2. The method of claim 1, wherein the step b is performed by a second IM client of the at least two IM clients between which the tone-modified voice communication channel is established, or is performed by a preset tone modifying device.

3. The method of claim 2, wherein the step a is performed after the second IM client receives a tone-modified voice communication response from the first IM client, the tone-modified voice communication response is responsive to a tone-modified voice communication request sent by the second IM client; or
wherein the tone-modified voice communication channel is established between the second IM client and the first IM client after the second IM client receives a voice communication response returned by the first IM client; wherein the voice communication response is responsive to a voice communication request sent by the second IM client.

4. The method of claim 1, wherein the processing the original voice information through the tone modification in the step b comprises:
collecting the original voice information inputted, converting the original voice information inputted into digital voice information; and processing the digital voice information through the tone modification.

5. The method of claim 1, wherein the tone modification comprises:
determining a tone modification manner; and
performing the tone modification according to the tone modification manner determined.

6. The method of claim 5, further comprising:
determining, before determining the tone modification manner, current tone modification information and service selection logic for determining the tone modification manner;
wherein the determining the tone modification manner comprises: determining the tone modification manner by the service selection logic based on the current tone modification information.

7. The method of claim 6, further comprising: obtaining characteristic information of the original voice information before determining the tone modification manner;
wherein the determining the tone modification manner comprises: determining the tone modification manner by the service selection logic based on the characteristic information and/or the current tone modification information.

8. The method of claim 7, wherein the tone-modified voice communication response comprises voice environment information of the first IM client;
wherein the determining the tone modification manner comprises: determining the tone modification manner by the service selection logic based on at least one of the voice environment information, the current tone modification information and the characteristic information.

9. The method of claim 4, further comprising:
performing noise removing to the digital voice information before processing the digital voice information through the tone modification.

10. The method of claim 1, further comprising:
before sending the tone-modified voice to the first IM client via the tone-modified voice communication channel, performing compressing and coding and/or redundancy enhancing to the tone-modified voice;
and/or
performing grouping and packing to the tone-modified voice.

11. The method of claim 1, further comprising:
establishing a voice communication channel between the at least two IM clients before establishing the tone-modified voice communication channel; and
releasing the voice communication channel after establishing the tone-modified voice communication channel.

12. An apparatus for voice communication based on an Instant Messaging (IM) system, comprising:
a request sending unit, adapted to establish a tone-modified voice communication channel;
a voice collecting unit, adapted to collect original voice information inputted;
a tone modifying unit, adapted to process the original voice information collected by the voice collecting unit through tone modification to obtain tone-modified voice;
a voice sending unit, adapted to send the tone-modified voice obtained by the tone modifying unit via the tone-modified voice communication channel established by the request transmitting unit.

13. The apparatus of claim 12, wherein the voice collecting unit is further adapted to convert the original voice information collected into digital voice information;
the tone modifying unit comprises:
a tone modification information determining module, adapted to determine and output current tone modification information;
a service logic module, adapted to generate and output service selection logic to be used by the tone modifying module to perform the tone modification;
a tone modifying module, adapted to determine a tone modification manner based on the tone modification information outputted by the tone modification information determining module and based on the service selection logic outputted by the service logic module, perform, according to the tone modification manner, the tone modification to the digital voice information obtained by the voice collecting unit, and output the tone-modified voice corresponding to the digital voice information.

14. The apparatus of claim 13, wherein the tone modifying unit further comprises: a user characteristic obtaining module and/or an opposite party environment obtaining module; wherein
the user characteristic obtaining module is adapted to obtain characteristic information from the digital voice information obtained by the voice collecting unit, generate and output the characteristic information;
the opposite party environment obtaining module is adapted to obtain and output opposite party voice environment information carried in a tone-modified voice communication response received by the request sending unit;
the tone modifying module is adapted to determine the tone modification manner based on the current tone modification information and the characteristic information; or based on the service selection logic, the current tone modification information and the opposite party voice environment information; or based on the service selection logic, the current tone modification information, the characteristic information and the opposite party voice environment information.

15. The apparatus of claim 13, further comprising:
a noise removing unit, adapted to receive the digital voice information obtained by the voice collecting unit, perform noise removing to the digital voice information, and obtain digital voice information which noise is removed from; and/or
a coding unit and/or optimizing unit;
wherein the coding unit is adapted to compress and code the tone-modified voice obtained by the tone modifying unit, and obtain tone-modified voice bit streams;
the optimizing unit is adapted to perform redundancy enhancing and/or grouping and packing to the tone-modified voice obtained by the tone modifying unit or to the tone-modified voice bit streams obtained by the coding unit, and output tone-modified voice data which are obtained by the optimizing unit through processing to the voice sending unit.

16. A method for voice communication based on an Instant Messaging (IM) system, comprising steps of:
establishing a voice communication channel between at least two IM clients;
processing original voice information through tone modification to obtain tone-modified voice after determining to perform tone-modified voice communication; and transmitting the tone-modified voice to a first IM client of the at least two IM clients via the voice communication channel.
